(19) United States
(12) Patent Application Publication
(10) Pub. No.: US 2025/0014459 A1
(43) Pub. Date: Jan. 9, 2025

(54) INFORMATION MANAGEMENT SYSTEM

(71) Applicant: TOYOTA JIDOSHA KABUSHIKI KAISHA, Toyota-shi (JP)

(72) Inventors: Yuko TERASAWA, Tokyo (JP); Tomoyoshi UEKI, Toyota-shi (JP); Masahiro KAGAMI, Nagoya-shi (JP); Yasuhide KURIMOTO, Kasugai-shi (JP); Hiroshi YAMASAKI, Nagoya-shi (JP); Kenji ZAITSU, Nisshin-shi (JP); Yoshihiko ENDO, Tokyo (JP)

(73) Assignee: TOYOTA JIDOSHA KABUSHIKI KAISHA, Toyota-shi (JP)

(21) Appl. No.: 18/664,560

(22) Filed: May 15, 2024

(30) Foreign Application Priority Data
Jul. 3, 2023 (JP) 2023-109101

(51) Int. Cl. G08G 1/01; G06Q 40/08

(52) U.S. Cl. CPC G08G 1/0133; G06Q 40/08; G08G 1/0129

(57) ABSTRACT

An information management system includes a data management device and a server. The data management device records the management information including the identification information of the power storage device, the identification information of the user using the power storage device, and the hash value of the use history information of the power storage device in the distributed ledger. The server is configured to be able to read management information. The server is configured to be able to acquire the use history information from the data management device. The server is configured to transmit the provision information based on the use history information in response to the transmission request. The provision information based on the use history information is information including at least one of use history information and information generated based on the use history information.

### CROSS-REFERENCE TO RELATED APPLICATION

This application claims priority to Japanese Patent Application No. 2023-109101 filed on Jul. 3, 2023, incorporated herein by reference in its entirety.

### BACKGROUND

### 1. Technical Field

The present disclosure relates to an information management system for a power storage device.

### 2. Description of Related Art

Japanese Unexamined Patent Application Publication (Translation of PCT Application) No. 2010-540907 (JP 2010-540907 A) discloses a technology of replacing a battery mounted on a vehicle with another battery having a large remaining power storage amount when the remaining power storage amount of the battery mounted on the vehicle decreases. In the system described in JP 2010-540907 A, the battery is replaced at a replacement station.

### SUMMARY

In the system described in JP 2010-540907 A, a battery removed from a vehicle is charged and provided to another vehicle at the replacement station. In such a system, a large number of power storage devices are used. Further, one power storage device is used by a plurality of users in sequence. For example, a power storage device used by one user may be provided to another user.

If the conditions of a plurality of power storage devices distributed in the system can be grasped, an appropriate power storage device can easily be provided to each user. Therefore, it is conceivable to manage pieces of information on the power storage devices by using a distributed ledger. The information recorded in the distributed ledger is shared by a plurality of nodes. Therefore, the information recorded in the distributed ledger is not easily manipulated.

If use history information of the power storage device for each user is provided to a service provider (for example, an insurance company), the service provider can easily provide a service (for example, an insurance service) suitable for each user. However, the use history information of the power storage device for the user corresponds to personal information of the user. If the personal information of the user recorded in the distributed ledger is shared by the nodes, the user's interest may be impaired.

An object of the present disclosure is to protect personal information of a user in use of a power storage device and to utilize the personal information as necessary.

An information management system according to an aspect of the present disclosure includes a data management device and a server. The data management device is configured to record, in a distributed ledger, management information including identification information of a power storage device, identification information of a user who has used the power storage device, and a hash value of use history information of the power storage device.

The server is configured to read the management information.

The server is configured to acquire the use history information from the data management device.

The server is configured to transmit provision information based on the use history information in response to a transmission request.

The provision information based on the use history information is information including at least one of the use history information and information generated based on the use history information.

According to the present disclosure, it is possible to protect the personal information of the user in use of the power storage device and to utilize the personal information as necessary.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an information management system according to an embodiment of the present disclosure;

FIG. 2 is a diagram showing a configuration of the information platform shown in FIG. 1;

FIG. 3 is a diagram for describing processing for recording management information in a distributed ledger in the information management system according to the embodiment of the present disclosure;

FIG. 4 is a diagram for describing management information recorded in a distributed ledger in the information management system according to the embodiment of the present disclosure;

FIG. 5 is a diagram for describing a process according to an information-management method according to an embodiment of the present disclosure; and

FIG. 6 is a flowchart illustrating a process for the analysis server illustrated in FIG. 1 to acquire use history information.

### DETAILED DESCRIPTION OF EMBODIMENTS

Embodiments of the present disclosure will be described in detail with reference to the drawings. In the drawings, the same or corresponding parts are denoted by the same reference numerals, and the description thereof will not be repeated.

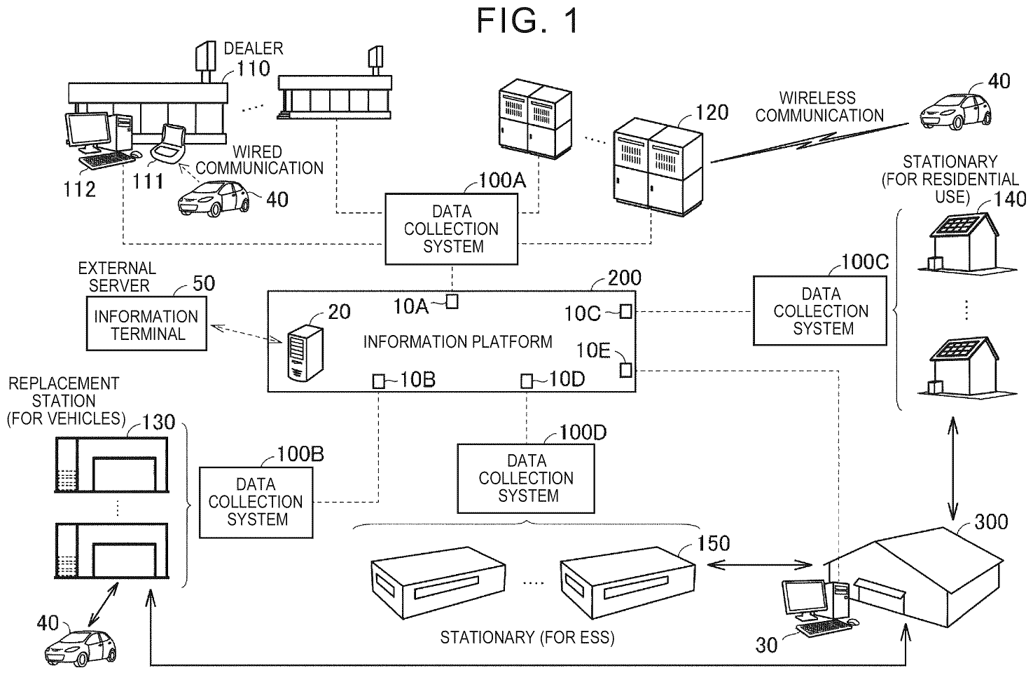

FIG. 1 is a diagram illustrating an outline of an information management system according to an embodiment. The information management system illustrated in FIG. 1 includes a management terminal 30, a plurality of vehicles 40, an information terminal 50, a 100D from a data collection system 100A, a plurality of dealers 110, a plurality of vehicle management devices 120, a plurality of replacement stations 130, a plurality of houses 140, a plurality of Energy Storage System (ESS) 150, an information platform 200, and a warehouse 300. In this system, a plurality of power storage devices is circulated. Each power storage device is sequentially used by a plurality of users. For example, a power storage device used by one user may be provided to another user. Each power storage device is provided with unique identification information (hereinafter, referred to as “battery ID”) so that each power storage device that is distributed in the system can be identified. The owner and the user of the power storage device are registered in the information platform 200, and unique identification information is added thereto. In addition, the use location (the vehicle 40, the house 140, ESS 150) and the storage location (the replacement station 130, the warehouse 300) of the power storage device are registered in the information platform 200, and unique identification information is given thereto.

A power storage device is mounted on each of the plurality of vehicles 40. In the vehicle 40, the power storage device functions as a drive battery. Each of the plurality of vehicles 40 travels using electric power output from the power storage device. A power storage device may be provided (rented) to a vehicle user (for example, an owner of a vehicle body) by a lease service provided by an automobile manufacturer. The identification information of the respective vehicles (hereinafter, referred to as “vehicle ID”) may be Vehicle Identification Number (VIN).

The dealer 110 includes a scanning tool 111 and a dealer terminal 112 (e.g., a computer). The scanning tool 111 acquires information (including vehicle ID and battery ID) from the vehicle 40 that has visited the dealer 110 through wired communication. The information of the vehicle 40 acquired by the scanning tool 111 is transmitted to the dealer terminal 112. The dealer terminal 112 manages information for each vehicle by distinguishing the information by vehicle ID.

The vehicle management device 120 includes a terminal (for example, a computer) configured to be capable of wirelessly communicating with the vehicle 40 that is traveling or stopped. The vehicle management device 120 acquires information (including the vehicle ID and the battery ID) from each of the plurality of vehicles 40 by radio communication. The vehicle management device 120 manages the information of the respective vehicles by distinguishing them by the vehicle ID.

The replacement station 130 is configured to store the replacement power storage device and exchange the power storage device mounted on the vehicle 40. Specifically, the replacement station 130 is configured to remove the power storage device from the vehicle 40 and attach the replacement power storage device to the vehicle 40.

The house 140 includes a photovoltaic power generation system and a stationary power storage system (a residential power storage system). The power storage system is configured to be capable of supplying power to the house 140. The power storage system can also store electric power generated by the photovoltaic power generation system.

ESS 150 is a stationary power storage system larger than the residential power storage system. ESS 150 serves as a power source for the power system or facilities. The power system is a power grid constructed by a transmission and distribution facility. Examples of facilities include factories and commercial facilities. ESS 150 may also store excess power. The power storage device used in ESS 150 has a larger capacity than the power storage device used in the house 140.

The warehouse 300 is configured to be capable of storing a plurality of power storage devices. The management terminal 30 manages information (inventory information) of each power storage device stored in the warehouse 300. The power storage device whose use is not determined is stored in the warehouse 300. Then, when the use of the power storage device is determined, the power storage device is transported from the warehouse 300 to the use location (for example, the house 140 or ESS 150) or another storage location (for example, the replacement station 130).

Vehicles 40, replacement stations 130, houses 140, ESS 150, and warehouses 300 each comprise a Battery Management System (BMS). BMS includes detectors (including various sensors) and controllers. The detector detects a state (e.g., temperature, current, voltage) of the power storage device. The controller records the detection result by the detector in the storage device in association with the detection time. However, BMS of the storage location may be omitted.

The data collection system 100A is configured to, for example, periodically collect, from each of the plurality of dealers 110 (the dealer terminals 112) and the plurality of vehicle management devices 120, information on the in-vehicle power storage device (information on the respective power storage devices used in the plurality of vehicles 40), and convert the collected information into a database. The information of the power storage device of each vehicle acquired by BMS of each vehicle is transmitted to the scanning tool 25 111 or the vehicle management device 120 by wired communication or wireless communication, respectively.

The data collection system 100B, 100C, 100D is configured to collect information on the exchange power storage devices (information on the respective power storage devices stored in the plurality of replacement stations 130), information on the residential power storage devices (information on the respective power storage devices used in the plurality of houses 140), information on ESS power storage devices (information on the respective power storage devices used in the plurality of ESS 150), and to database the collected information. BMS in each of the replacement station 130, the house 140, and ESS 150 transmit the power storage device information to the corresponding data collection system in response to a request from the corresponding data collection system or periodically.

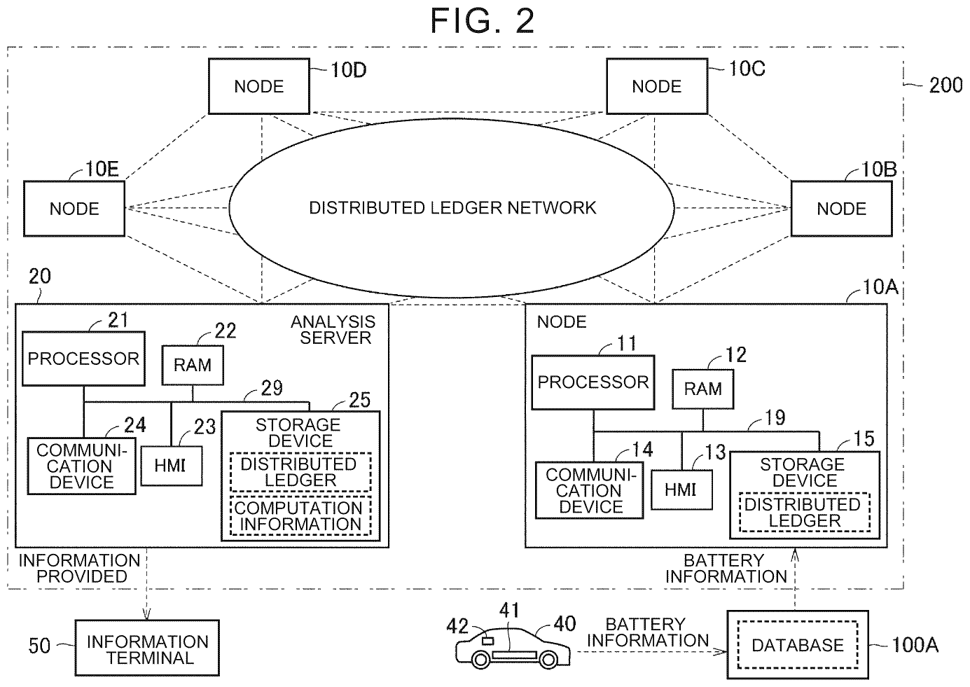

The information platform 200 includes a node 10A, 10B, 10C, 10D, 10E (for example, a computer) corresponding to each of the data collection system 100A, 100B, 100C, 100D and the management terminal 30. The information platform 200 further comprises a server 20. These nodes and the server 20 form a distributed ledger network (hereinafter referred to as “DLN”). However, the number of nodes can be changed as appropriate. The information platform 200 manages information of the respective power storage devices distributed in the system by using a distributed ledger technique using, for example, a blockchain (hereinafter, referred to as “BLC”). In the distributed ledger, all the information from the start of the operation of the distributed ledger to the present is recorded. FIG. 2 is a diagram illustrating a configuration of the information platform 200.

As shown in FIG. 2, the node 10A includes a processor 11, a Random Access Memory (RAM) 12, a Human Machine Interface (HMI) 13, a communication device 14, and a storage device 15, which are connected to a bus 19. The storage device 15 includes, for example, a hard disk or a flash memory, and is configured to be able to store information. The storage device 15 stores a distributed ledger. Although FIG. 2 shows only the configuration of the node 10A, the node 10B and 10E are basically the same as the node 10A shown in FIG. 2.

The server 20 also has distributed ledgers and function as DLN nodes. The information recorded in the distributed ledger is shared by all the nodes of DLN. The server 20 also functions as an analysis server that analyzes the data added to the distributed ledger by 10E from the node 10A. The server 20 includes a processor 21, a RAM 22, an HMI 23, a communication device 24, and a storage device 25, which are connected to a bus 29. The storage device 25 stores a distributed ledger. The storage device 25 further stores information (operation information) for information analysis.

The vehicles 40 are, for example, battery electric vehicle (BEV). The vehicles 40 include a battery 41 and an Electronic Control Unit (ECU) 42. As the battery 41, a known electric storage device for a vehicle (for example, a secondary battery) can be adopted. ECU 42 is a control device including a processor and a storage device. Vehicle 40 further includes a radio communication device (e.g., a Data Communication Module (DCM)). The vehicle 40 may include a camera that acquires an image around the vehicle 40, a drive recorder that records an image acquired by the camera, and an impact force sensor that detects an impact force applied to a vehicle body (for example, a body shell) of the vehicle 40.

The information terminal 50 according to this embodiment is an external server including a processor and a storage device. The information terminal 50 provides an insurance service using information (provision information) obtained from the information platform 200.

In the information management system illustrated in FIG. 1, the node 10A and the data collection system 100A function as a “first data management device”, the node 10B and the data collection system 100B function as a “second data management device”, the node 10C and the data collection system 100C function as a “third data management device”, the node 10D and the data collection system 100D function as a “fourth data management device”, and the node 10E and the management terminal 30 function as a “fifth data management device”. Hereinafter, in a case where the first to fifth data management devices are not distinguished from each other, these apparatuses are simply referred to as “data management devices”.

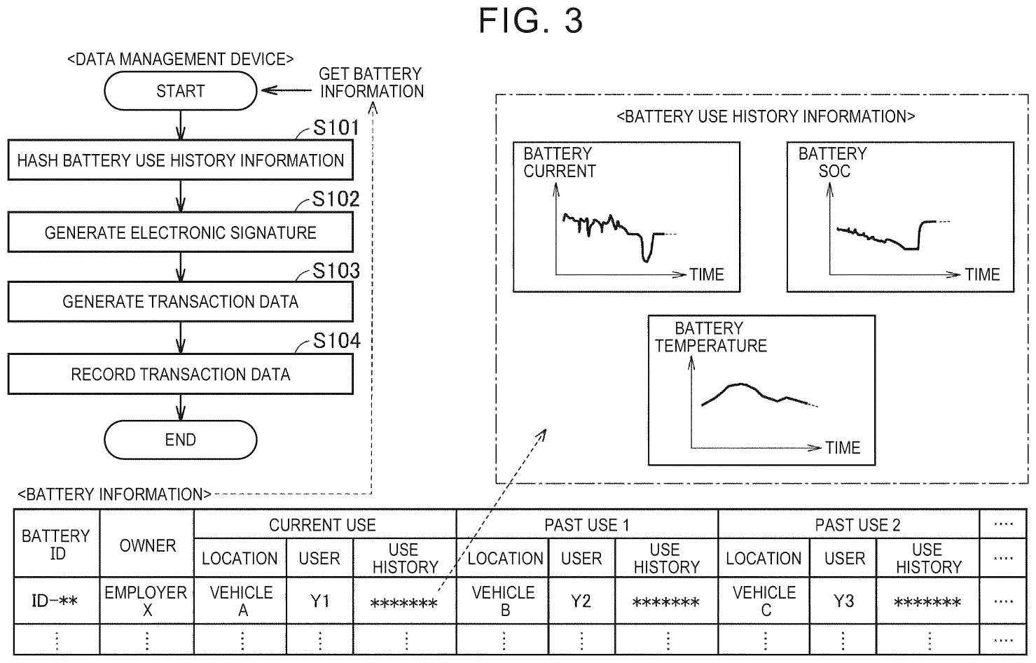

FIG. 3 is a diagram for explaining a process for the data management device to record management information in a distributed ledger. Hereinafter, each step in the flowchart is simply referred to as “S”. The process flow from S101 to S104 is executed by each of the nodes 10A to 10E. The data management device starts this processing flow when new battery information is acquired.

The battery information includes identification information (battery ID) of the power storage device, identification information (owner ID) of the owner of the power storage device, identification information (user ID) of the user using the power storage device, identification information (e.g., vehicle ID) of the use location of the power storage device, and use history information of the power storage device. However, the battery information is not limited to these pieces of information, and may further include other information related to the power storage device (for example, material composition information, specification information, insurance contract information, and performance evaluation information).

The use history information of the power storage device indicates, for example, a state transition of the power storage device during a certain use period. The use history information of the power storage device may include at least one of current data (a “current-time” graph) indicating a transition of the current of the power storage device, power storage amount data (a “SOC-time” graph) indicating a transition of State Of Charge (SOC) of the power storage device, and temperature data (a “temperature-time” graph) indicating a transition of the temperature of the power storage device. Information on the use of the power storage device is distinguished for each user, for example, as shown in the table in FIG. 3. The target power storage device shown in this chart is currently in use in the vehicle A by the user Y1 (first user), and is lent to the user Y1 from the operator X that is the owner. Further, the target power storage device is used in the vehicle B by the user Y2 (second user) prior to the user Y1, and is further used in the vehicle C by the user Y3 (third user) prior to the user Y2. The battery information of the target power storage device includes first use history information of the target power storage device by the user Y1, second use history information of the target power storage device by the user Y2, and third use history information of the target power storage device by the user Y3.

When the data management device acquires new battery information, the corresponding node adds the battery information to the distributed ledger according to the following processing flow. However, the use history information of the power storage device is hashed and then recorded in the distributed ledger, and the use history information before the hashing is not recorded in the distributed ledger.

In S101, the data management device acquires the hash value of the use history information by hashing the use history information included in the new battery information by using the hash function. In a subsequent S102, the data management device uses the private key to encrypt the hash of the use history information obtained in S101 to generate an electronic signature. Electronic signatures improve the reliability of information protection. However, it is not essential to generate an electronic signature.

Subsequently, in S103, the data management device generates transactional data including the management information, the identification information (the recorder ID) of the data management device, and the recording time. In this embodiment, the electronic signature (the hash value of the encrypted use history information) acquired by S102 and the above-described battery information excluding the use history information correspond to the management information. In a subsequent S104, the data management device records a new block in the distributed ledger that includes the transaction data generated by S103 and the hash-value of the previous transaction data (previous block). As a result, the distributed ledgers of the respective nodes of DLN are updated. Various kinds of information included in the new block are linked to each other.

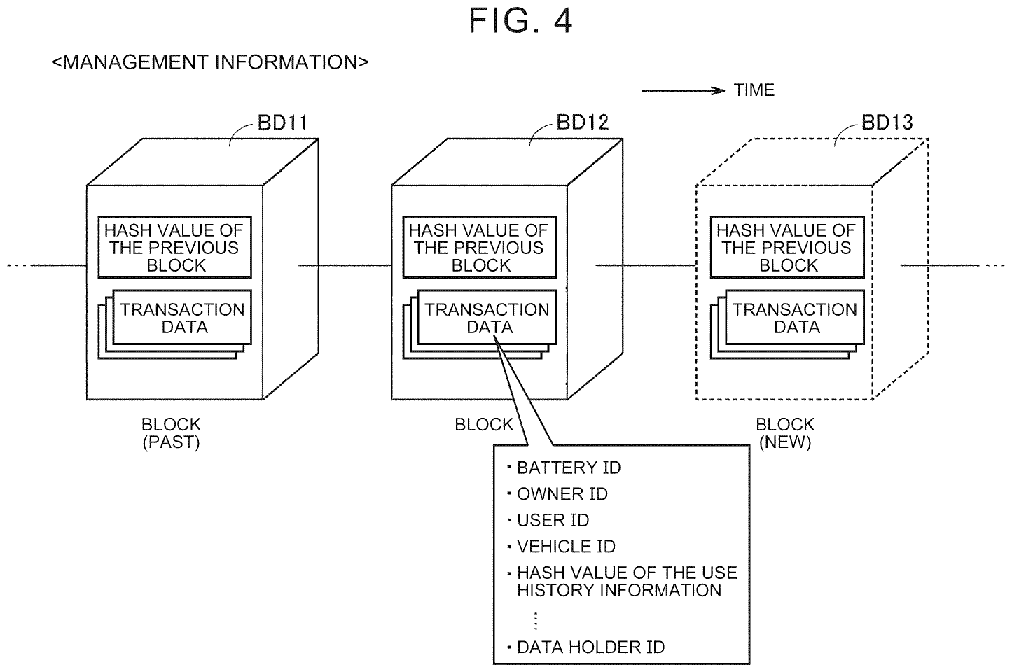

FIG. 4 is a diagram for explaining management information recorded in a distributed ledger. As shown in FIG. 4, BLC is composed of a plurality of blocks connected together. From the block BD 11 in FIG. 4, BD 13 is newer as it goes to the right. If they are arranged in order from the oldest, they become block BD 11, BD 12, BD 13. BLC indicates a history of transactions. Referring to FIG. 4, the data management device generates transaction data corresponding to the data addition (transaction) (S103) and transmits the generated transaction data to DLN (S104). Thereafter, when the predetermined requirement is satisfied, a new block BD 13 is added to the pre-existing block BD 11, BD 12. For example, a new block BD 13 is added to BLC by a mining process called Proof of Work (POW). POW is a mechanism for competing for the addition of a new block BD 13 between a plurality of nodes. Nodes participating in POW are commonly referred to as negative. The minus that generated the new block BD 13 the earliest is rewarded. BLC data-tampering resistance is ensured by the consensus-forming algorithm using such a mechanism.

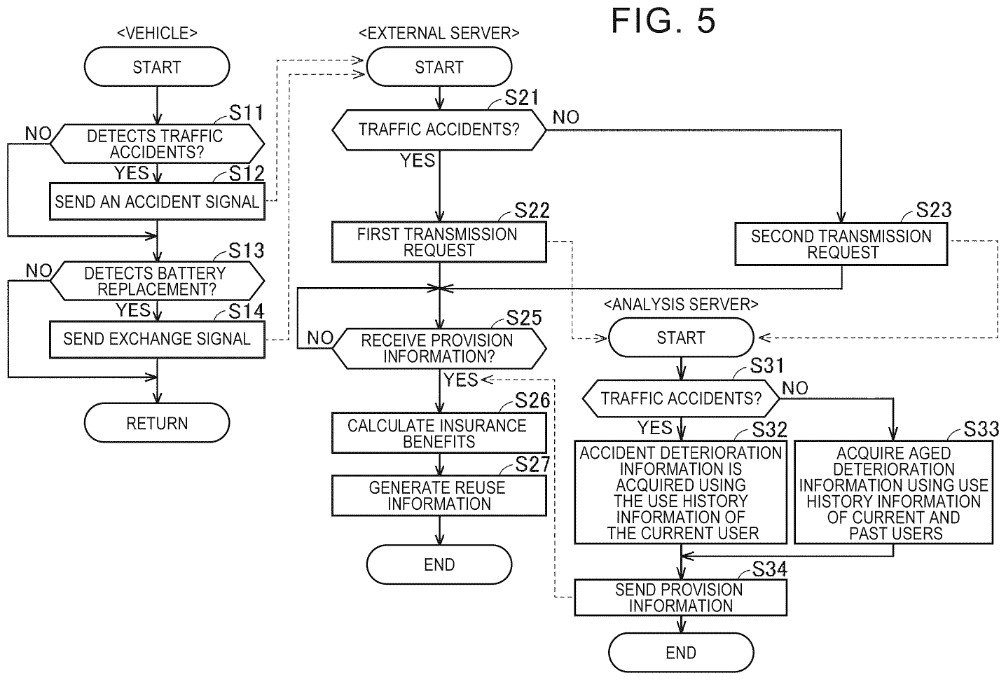

FIG. 5 is a diagram for describing processing according to the information management method according to the embodiment. ECU 42 of the vehicles 40 repeatedly executes the process flow of S14 from S11.

In S11, ECU 42 determines whether or not a traffic crash of the vehicles 40 has been detected. ECU 42 may use at least one of the impact force detected by the impact force sensor and the video recorded by the drive recorder to determine whether or not a traffic accident has occurred in the vehicle 40. When a traffic accident is detected (YES in S11), ECU 42 transmits an accident signal indicating that a traffic accident of the vehicle 40 has occurred to the information terminal 50 together with the vehicle ID of the vehicle 40 in a subsequent S12. On the other hand, if no traffic crash is detected (NO at S11), S12 is skipped and the process proceeds to S13.

In S13, ECU 42 determines whether or not the battery 41 mounted on the vehicle 40 has been replaced. ECU 42 may read the identification information (battery ID) of the battery 41 and determine whether the battery 41 has been replaced based on whether the battery ID has changed. Alternatively, ECU 42 may determine that the battery 41 has been replaced when it receives a signal from the dealer 110 or the replacement station 130 indicating completion of the battery replacement. If a battery replacement is detected (YES in S13), ECU 42 transmits, in a subsequent S14, a replacement signal indicating that the battery 41 of the vehicle 40 has been replaced together with the vehicle ID of the vehicle 40 to the information terminal 50. On the other hand, if no battery replacement is detected (NO at S13), S14 is skipped and the process returns to the first step (S11).

Upon receiving the fault signal or the interchange signal from the vehicle 40, the information terminal 50 starts S27 process from S21. The information terminal 50 identifies the target vehicle (vehicle 40) based on the vehicle ID. In S21, the information terminal 50 determines whether or not a traffic accident has occurred in the target vehicle. When this processing flow is started based on the accident signal, the information terminal 50 determines that the processing flow is YES in S21, and advances the processing to S22. Further, although this processing flow is started based on the replacement signal, the information terminal 50 similarly advances the processing to S22 even when a predetermined period (hereinafter referred to as an “accident handling period”) has not elapsed from the reception of the previous accident signal. The accident handling period can be arbitrarily set, and may be one day or one week. When the information terminal 50 has not previously received an accident signal for the target vehicle, the information terminal 50 determines NO in S21, and advances the process to S23. In addition, when this processing flow is started based on the interchangeable signal and the accident handling period has elapsed from the reception of the previous accident signal, the information terminal 50 similarly advances the processing to S23.

In both S22 and S23, the information terminal 50 requests the server 20 to transmit the provision information based on the use history information of the target power storage device mounted on the target vehicle (transmission request). The information terminal 50 transmits a signal for the transmission request to the server 20 together with the vehicle ID of the target vehicle. However, a signal transmitted by S22 (hereinafter, referred to as “first transmission-request signal”) indicates that a traffic accident has occurred in the target vehicle. The signal transmitted by S23 (hereinafter referred to as “second transmission request signal”) indicates that the traffic accident of the target vehicle has not occurred and the target power storage device has been removed from the target vehicle. When a transmission-request is made to the server 20 by any one of the processes of S22 and S23, the process proceeds to S25. The information terminal 50 determines whether or not the provision information is received from the server 20 in S25, and does not proceed with the process while the provision information is not received.

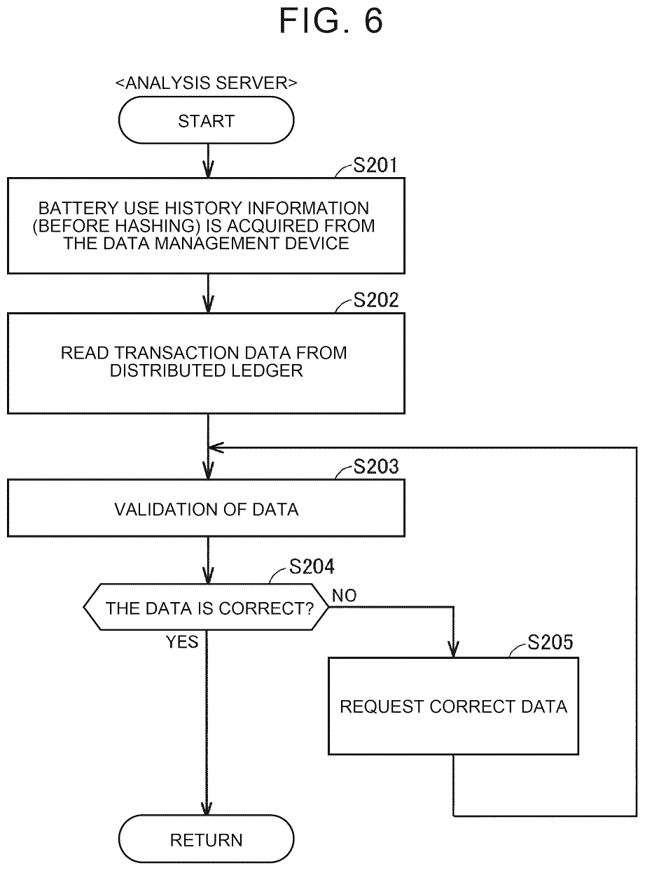

Upon receiving the first or second transmission-request signal from the information terminal 50, the server 20 starts S34 process from S31. In S31, the server 20 determines whether or not a traffic accident has occurred in the target vehicles. When this processing flow is started based on the first transmission request signal, the server 20 determines YES in S31 and advances the processing to S32. When this processing flow is started based on the second transmission request signal, the server 20 determines NO in S31 and advances the processing to S33. In S32 and S33, the server 20 generates the provision information by using at least one of the use history information of the target power storage device by the present user and the use history information of the target power storage device by the past user. At this time, the server 20 acquires the use history information of the target power storage device from the first data management device (node 10A) by a series of processes illustrated in FIG. 6, for example.

FIG. 6 is a flowchart illustrating a process for the server 20 to acquire use history information. Hereinafter, an exemplary power storage device in which the target power storage device is the power storage device used by Y3 from the user Y1 shown in the tables in FIG. 3 will be described. By referring to the distributed ledger, the server 20 can acquire the battery data of the target power storage device from the vehicle ID of the target vehicle.

In S201, the server 20 requests the first data management device (node 10A) to transmit the use history information for all the usage periods of the target power storage device. The server 20 may designate the target power storage devices according to the vehicle ID or the battery ID. In response to a request from the server 20, the first data management device transmits the use history information of the target power storage device to the server 20 in the same format as BLC data (management information recorded in the distributed ledger). Here, the use history information of the target power storage device to be transmitted is divided into blocks, and is composed of a plurality of blocks (see FIG. 4).

In S202, the server 20 reads the transaction data corresponding to the use history information in the distributed ledger. Then, the server 20 decrypts the electronic signature included in the transaction data using the public key corresponding to the private key (S102 in FIG. 3). The public key may be stored in the storage device 25 in advance. Alternatively, the server 20 may obtain the public key from the holder of the predetermined public key (e.g., the first data management device or the certification authority). When the decoding succeeds, the server 20 can acquire the hash value of the use history information. Successful decoding means that the recorder is correct. Further, the server 20 can acquire battery information other than the use history information from the transaction data.

In S203, the server 20 checks the validity of the use history information acquired from the first data management device. Specifically, the server 20 acquires the hash value of the use history information by hashing the use history information acquired by S201 using the hash function. Then, the server 20 checks the validity of the data by comparing the hash value of the use history information obtained by the hashing with the hash value of the use history information obtained from the distributed ledger by S202. A match between the hash values of the two means that the data is correct. A mismatch between the hash values of the two means that the data is incorrect. The validity of the data is checked for each block.

In S204, the server 20 determines whether or not the use history information acquired from the first data management device is correct. When it is determined that the use history information is incorrect due to S203 check (NO in S204), the server 20 specifies an incorrect part (block) of the use history information in S205 and requests the first data management device to transmit the correct use history information. In response to a request from the server 20, the first data management device transmits, to the server 20, the use history information stored in a location different from the use history information transmitted by S201. The first data management device may transmit backup data (e.g., data stored in the data collection system 100A). Thereafter, the process returns to S203. In S203, the server 20 checks the validity of the use history information acquired by S205. When it is determined that the use history information is correct by checking S203 (YES in S204), the use history information is acquired. In each of S32 and S33 in FIG. 5, the server 20 generates the provision information using the use history information.

Referring back to FIG. 5, in S32, the server 20 generates provision information (hereinafter, referred to as “provision information Z1”) indicating the value loss of the target power storage device due to a traffic accident using the use history information (first use history information) of the target power storage device by the present user (user Y1). For example, the difference between State of Health (SOH) before and after the accident corresponds to the value lost by the traffic accident. Exemplary SOH include capacity retention, full charge capacity, and the inverse of the inner resistance. The server 20 may calculate the value loss of the target power storage device from the first use history information by using the first arithmetic expression stored in advance in the storage device 25. There is a correlation between the state transition of the target power storage device associated with the accident and the deterioration progress (damage degree) of the target power storage device. A mathematical expression representing this correlation corresponds to the first arithmetic expression.

In S33, the server 20 generates provision information (hereinafter, referred to as “provision information Z2”) indicating the value loss of the target power storage device caused by the aging degradation by using the use history information of the target power storage device by the present user and the use history information of the target power storage device by the past user. In this embodiment, use history information for all users is used. Specifically, the server 20 generates the provision information Z2 using the first use history information related to the user Y1, the second use history information related to the user Y2, and the third use history information related to the user Y3 with respect to the target power storage device illustrated in FIG. 3. The provision information Z2 indicates a value-loss amount for each user. The server 20 may calculate the value loss of the target power storage device from the first to third use history information by using the second arithmetic expression stored in advance in the storage device 25. There is a correlation between the state transition of the target power storage device associated with the use of the target power storage device and the deterioration progress of the target power storage device. A mathematical expression representing this correlation corresponds to the second arithmetic expression.

When the provision information Z1 or Z2 is generated by S32 or S33 process, the server 20 transmits the generated provision information Z1 or Z2 to the information terminal 50 in S34. As a result, S34 process from S31 ends.

The server 20 can provide the information terminal 50 with the provision information (the first provision information, the second provision information, and the third provision information) based on the use history information of each user when there is a use history related to a plurality of users with respect to the target power storage device. The provision information Z1 includes only the first provision information among the first provision information based on the first use history information, the second provision information based on the second use history information, and the third provision information based on the third use history information. When a traffic accident occurs in the target vehicle, there is a high possibility that the target power storage device has deteriorated mainly due to the traffic accident. The information on the state of the target power storage device before and after the occurrence of the traffic accident is considered to be the first provision information. Therefore, the server 20 provides only the first provision information to the information terminal 50. Meanwhile, the provision information Z2 includes first to third provision information. When the target power storage device is removed from the target vehicle without causing a traffic accident, it is highly likely that the use of the target power storage device cannot be continued due to aging deterioration. It is considered that not only the first provision information but also the second and third provision information (in particular, the second provision information) are related to the aging deterioration of the target power storage device. Therefore, the server 20 provides the first to third provision information to the information terminal 50. According to the information management system of this embodiment, the personal information of the past user is provided to the information terminal only when the necessity is high. Accordingly, it is possible to achieve both protection and use of personal information of past users.

When the information terminal 50 receives the provision information Z1 or Z2 from the server 20 (YES in S25), the process proceeds to S26. In S26, the information terminal 50 calculates the insurance money using the provision information Z1 or Z2. In the following S27, the information terminal 50 generates information on reuse of the target power storage device removed from the target vehicle (hereinafter, referred to as “reuse information”). When S27 process is executed, S27 process from S21 ends.

Specifically, when a traffic accident occurs in the target vehicle, the information terminal 50 receives the provision information Z1 from the server 20, and uses the provision information Z1 to calculate an insurance benefit for compensating for a value loss of the target power storage device due to the traffic accident. The provision information Z1 indicates a value-loss amount of the target power storage device due to a traffic accident. Therefore, the server 20 can calculate the insurance money corresponding to the value loss of the target power storage device due to the traffic accident. The calculated insurance benefits are paid from the insurance provider to the current user. According to the information management system of this embodiment, it is easy to appropriately provide the insurance service for compensating the value loss of the target power storage device due to the traffic accident.

When a traffic accident occurs in the target vehicle, the information terminal 50 generates, in S27, reuse information indicating that the use of the target power storage device for reuse is undetermined. When the target power storage device is removed from the target vehicle within S21, the information terminal 50 transmits the reuse information to the server 20. The server 20 may record the received reuse information of the target power storage device in the distributed ledger. In this case, the target power storage device is transported to the warehouse 300 and inspected by the warehouse 300. The management terminal 30 determines an application for reuse based on the inspection result. The node 10E may record the use of the target power storage device determined by the management terminal 30 in the distributed ledger.

When the traffic accident of the target vehicle has not occurred and the target power storage device has been removed from the target vehicle, the information terminal 50 receives the provision information Z2 from the server 20, and divides the value loss of the target power storage device caused by the aging degradation into a value loss due to the use of the present user (the user immediately before the replacement) and a value loss due to the use of the past user by using the provision information Z2. Then, the information terminal 50 calculates an insurance benefit for compensating for a value loss due to use by a user in the past. The server 20 may calculate an insurance benefit to compensate for a value loss that is not the responsibility of the current user. The calculated insurance benefits are paid to the current user. According to the information management system of this embodiment, it is easy to appropriately provide an insurance service for compensating for a value loss due to aging deterioration with respect to a target power storage device that is sequentially used by a plurality of users.

Further, the information terminal 50 estimates the value of the target power storage device using the provision information Z2, and determines the use for reuse of the target power storage device removed from the target vehicle based on the estimated value. The provision information Z2 includes not only information about the use of the target power storage device by the present user but also information about the use of the target power storage device by the past user. Therefore, the information terminal 50 can estimate the value (residual value after aging degradation) of the target power storage device with high accuracy. According to the information management system of this embodiment, it is easy to appropriately determine the use for reuse of the target power storage device removed from the target vehicle. The information terminal 50 may choose one application from the options including the replacement station 130, the house 140, and ESS 150. The information terminal 50 transmits reuse information indicating the determined use to the server 20. The server 20 may record the received reuse information of the target power storage device in the distributed ledger. The target power storage device may be transported to a place (a use place or a storage place) corresponding to the use indicated by the reuse information.

As described above, the information management system according to this embodiment includes the first to fifth data management devices and the server 20. Each of the first to fifth data management devices records management information including identification information of the power storage device, identification information of the user using the power storage device, and a hash value of the use history information of the power storage device in a distributed ledger. The server 20 is configured to be able to read management information. The server 20 is configured to be able to acquire the use history information from each of the first to fifth data management devices. For example, the server 20 can acquire the use history information related to the in-vehicle power storage device from the first data management device. In response to a transmission request from the information terminal 50, the server 20 transmits the provision information based on the use history information to the information terminal 50.

In the information management system, the server 20 can read the hash value of the use history information of the power storage device from the management information (distributed ledger). In addition, the server 20 can acquire the unhashed use history information from the data management device. The server 20 can hash the acquired use history information and confirm whether or not the use history information is correct based on whether or not the obtained hash value matches the hash value read from the management information. Then, the server 20 can transmit the provision information based on the correct use history information in response to an external request. The management information includes the hash value of the use history information, but does not include the use history information that is not hashed. Therefore, the use history information (personal information of the user) is protected. As described above, according to the information management system, it is possible to utilize the personal information of the user as needed while protecting the personal information of the user with respect to the use of the power storage device.

In the information management system, the processes illustrated in FIGS. 3, 5, and 6 are executed. Each process is executed by one or more processors executing programs stored in one or more memories. However, these processes may be executed by dedicated hardware (electronic circuit) instead of software.

It is not essential that the provision information Z2 in S33 of FIG. 5 includes the first to third provision information. Only the first and second provision information related to the present user (user Y1) and the immediately preceding user (user Y2) may be included in the provision information Z2. In S32 and S33 of FIG. 5, the server 20 generates the provision information based on the use history information. However, the present disclosure is not limited thereto, and the server 20 may transmit the use history information itself as the provision information to the information terminal 50. Further, the server 20 may transmit the provision information including both the use history information and the information generated based on the use history information to the information terminal 50. The use history information is not limited to the data illustrated in FIG. 3, and may be any information indicating the state of the power storage device in use.

The server 20 may record the hash value of the operation information (including the first and second operation expressions) in the distributed ledger so as to prove the calculation method of the value loss as necessary. In S32 of FIG. 5, the server 20 may generate provision information indicating SOH of the target power storage device immediately before the traffic accident by using the use history information of the target power storage device, and transmit the provision information to the information terminal 50 instead of the provision information Z1. In addition, the target power storage device may be inspected in the warehouse 300 after the traffic accident. Then, the management terminal 30 may transmit SOH of the target power storage device after the traffic accident to the information terminal 50 based on the test result. The information terminal 50 may calculate an insurance benefit corresponding to a value-loss portion of the target power storage device due to the traffic accident based on SOH of the target power storage device before and after the accident.

The vehicles 40 are not limited to BEV, and may be electrified vehicle (e.g., plug-in hybrid electric vehicle) other than BEV. Vehicle 40 may be an automated guided vehicle (AGV) or agricultural equipment.

The embodiments disclosed herein should be considered to be exemplary and not restrictive in all respects. The scope of the present disclosure is shown by the scope of claims rather than the description of the above embodiment, and is intended to include all modifications within the meaning and the scope equivalent to the scope of claims.

What is claimed is:

1. An information management system comprising:
a data management device configured to record, in a distributed ledger, management information including identification information of a power storage device, identification information of a user who has used the power storage device, and a hash value of use history information of the power storage device; and
a server configured to read the management information, wherein:
the server is configured to acquire the use history information from the data management device;
the server is configured to transmit provision information based on the use history information in response to a transmission request; and
the provision information based on the use history information is information including at least one of the use history information and information generated based on the use history information.

2. The information management system according to claim 1, further comprising an information terminal configured to send the transmission request for a target power storage device mounted on a vehicle currently in use by a first user, wherein the server is configured to:
receive the transmission request from the information terminal; and
when the target power storage device was used by a second user before the first user, transmit, to the information terminal, at least one of first provision information based on first use history information of the target power storage device for the first user and second provision information based on second use history information of the target power storage device for the second user.

3. The information management system according to claim 2, wherein:
the server is configured to, when a traffic accident of the vehicle has occurred, transmit only the first provision information out of the first provision information and the second provision information to the information terminal in response to the transmission request from the information terminal; and
the server is configured to, when a traffic accident of the vehicle has not occurred and the target power storage device has been removed from the vehicle, transmit the first provision information and the second provision information to the information terminal in response to the transmission request from the information terminal.

4. The information management system according to claim 3, wherein:
the server is configured to, when a traffic accident of the vehicle has occurred, generate the first provision information indicating a value loss of the target power storage device due to the traffic accident and transmit the generated first provision information to the information terminal in response to the transmission request from the information terminal; and
the information terminal is configured to, when the traffic accident of the vehicle has occurred, calculate an insurance benefit for compensating for the value loss of the target power storage device due to the traffic accident by using the first provision information received from the server.

5. The information management system according to claim 3, wherein the information terminal is configured to, when a traffic accident of the vehicle has not occurred and the target power storage device has been removed from the vehicle, estimate a value of the target power storage device by using the first provision information and the second provision information and determine an application for reuse of the target power storage device removed from the vehicle based on the estimated value.
